(19) United States
(12) Patent Application Publication
(10) Pub. No.: US 2007/0053009 A1
(43) Pub. Date: Mar. 8, 2007

(54) Image processing method, image processor, and image forming apparatus

(76) Inventors: Takanori Ito, Kanagawa (JP); Shuji Kimura, Kanagawa (JP); Toshiya A. Hikita, Tokyo (JP); Takumi Nozawa, Kanagawa (JP); Tomoyuki Yoshida, Tokyo (JP); Satoshi Ohkawa, Tokyo (JP); Yasunobu Shirata, Tokyo (JP); Yukihiko Tamura, Kanagawa (JP); Masato Ishii, Tokyo (JP); Takeharu Tone, Kanagawa (JP); Hiroyuki Kawamoto, Kanagawa (JP); Atsushi Togami, Kanagawa (JP); Toshimi Yamamura, Kanagawa (JP); Akira Murakata, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/516,434

(22) Filed: Sep. 5, 2006

(30) Foreign Application Priority Data
Sep. 6, 2005 (JP) 2005-258476
Aug. 7, 2006 (JP) 2006-214685

(51) Int. Cl. H04N 1/393

(52) U.S. Cl. 358/451

(57) ABSTRACT

An image processing method that stores image data in a storage unit is disclosed. The image data and data related to processing performed on the image data are stored in correlation with each other in the storage unit.

### PRIORITY

The present application claims priority to and incorporates by reference the entire contents of Japanese Patent Application No. 2005-258476 filed in Japan on Sep. 6, 2005 and Japanese Patent Application No. 2006-214685 filed in Japan on Aug. 7, 2006.

### BACKGROUND OF THE INVENTION

1. Field of the Invention

The present invention relates generally to image processing methods, image processors, and image forming apparatuses, and more particularly to an image processing method, an image processor, and an image forming apparatus that store image data in a storage unit and manage the image data.

2. Description of the Related Art

An image processor including: an original reading unit that reads original material and outputs image data; an image visualization unit that visualizes the image data (processes the image data so that a visible image may be produced); and further a nonvolatile image storage unit that semipermanently stores the image data, wherein the image data stored in the nonvolatile image storage unit can be reused later for producing a visible image, is known.

Further, there is proposed an image processor that stores not only image data but also a combination of a password and job data in a storage unit (see, for example, Japanese Laid-Open Patent Application No. 2004-274556).

The job data specify or determine the start and end pages of image data to be printed and the number of copies to be printed of the image data; paper size; the type of painting (color or monochrome); the necessity of punching paper; the necessity of stapling paper; the necessity of automatically folding paper after an image has been formed thereon; and the necessity of printing multiple images by allocating them to a single sheet of paper (N in one or imposition).

However, regarding the conventional image processor, no consideration has been given to operations in the case of later reuse of image data stored in the nonvolatile image storage unit. Therefore, a user has to repeat a similar or the same operational procedure each time, so that there are problems of troublesomeness, inefficiency, and poor usability.

Further, the above-mentioned apparatus of Japanese Laid-Open Patent Application No. 2004-274556, which stores a combination of a password and job data in the storage unit, is better in usability in the case of outputting data under the same conditions, that is, re-outputting data. However, no consideration is given to changing paper size or a printing type (color printing or monochrome printing) in the case of reusing data. Therefore, the apparatus of Japanese Laid-Open Patent Application No. 2004-274556 is still poor in usability.

### SUMMARY OF THE INVENTION

An image processing method, image process, and image forming apparatus are disclosed. In one embodiment, an image processing method stores image data in a storage unit, wherein the image data and data related to processing performed on the image data are stored in correlation with each other in the storage unit.

### DESCRIPTION OF THE DRAWINGS

Other embodiments, features and advantages of the present invention will become more apparent from the following detailed description when read in conjunction with the accompanying drawings, in which:

FIG. 1 is a diagram showing a system configuration according to an embodiment of the present invention;

FIG. 2 is a block diagram showing a scanner unit and an IPU-A unit according to the embodiment of the present invention;

FIG. 3 is a block diagram showing an IPU-B unit and a printer unit according to the embodiment of the present invention;

FIG. 4 is a block diagram showing a storage unit according to the embodiment of the present invention;

FIG. 5 is a block diagram showing an IPU-C unit according to the embodiment of the present invention;

FIG. 6 is a diagram showing a data configuration of an HDD according to embodiment of the present invention;

FIG. 7 is a diagram for illustrating bibliographic information according to the embodiment of the present invention;

FIGS. 8A and 8B are diagrams showing TPD screens of an operations display unit according to the embodiment of the present invention;

FIGS. 9A and 9B are diagrams showing TPD screens of the operations display unit according to the embodiment of the present invention;

FIGS. 10A and 10B are diagrams showing TPD screens of the operations display unit according to the embodiment of the present invention;

FIG. 11 is a diagram showing a TPD screen of the operations display unit according to the embodiment of the present invention;

FIG. 12 is a diagram showing a TPD screen of the operations display unit according to the embodiment of the present invention;

FIG. 13 is a flowchart of processing of a controller unit at the time of storing an image according to the embodiment of the present invention; and

FIG. 14 is a flowchart of processing of the controller unit at the time of outputting a stored image according to the embodiment of the present invention.

### DETAILED DESCRIPTION OF THE PREFERRED EMBODIMENTS

Embodiments of the present invention may solve or reduce one or more of the above problems.

Embodiments of the present invention include an image processing method, an image processor, and an image forming apparatus in which the above-described problems are solved.

Embodiments of the present invention also include an image processing method, an image processor, and an image forming apparatus that can improve usability in the case of reusing image data stored in a storage unit.

According to one embodiment of the present invention, there is provided an image processing method that stores image data in a storage unit, wherein the image data and data related to processing performed on the image data are stored in correlation with each other in the storage unit.

According to one embodiment of the present invention, there is provided an image forming apparatus that stores and manages image data in a storage unit, the image forming apparatus including a control unit configured to store the image data and data related to processing performed on the image data in correlation with each other in the storage unit.

According to one embodiment of the present invention, there is provided an image processor including a selection unit to select desired image data from image data stored in a storage unit; and a setting changing unit to display data related to processing, the data being stored in correlation with the selected image data in the storage unit, and to change an output setting based on the displayed processing-related data.

According to one embodiment of the present invention, image data and data related to processing performed on the image data are stored in correlation with each other in a storage unit, and necessary bibliographic information is obtained referring to the image data stored in the storage unit at the time of image reading. Thereby, it is possible to utilize initial values, so that it is possible to omit unnecessary setting operations. As a result, it is possible to improve usability.

A description is given below, with reference to the accompanying drawings, of an embodiment of the present invention.

System Configuration

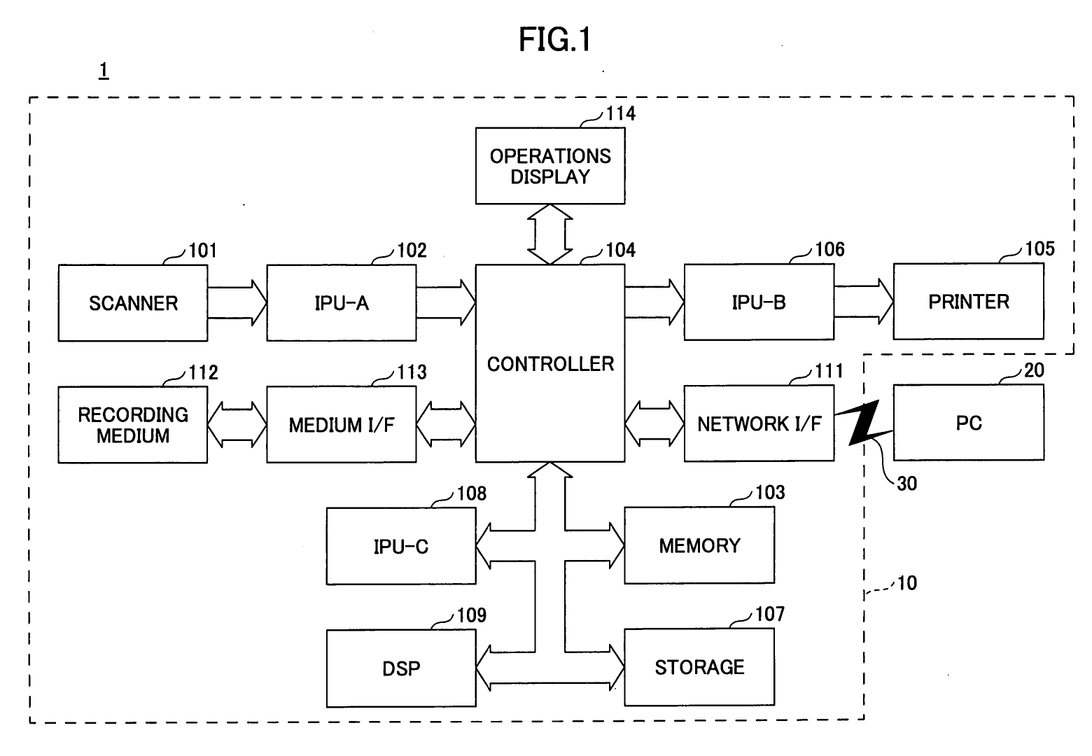

FIG. 1 is a diagram showing a system configuration according to the embodiment of the present invention.

According to an image processing system 1 of this embodiment, an image forming apparatus 10 and a personal computer (PC) 20 can communicate with each other through a network 30.

The image forming apparatus 10, which is a so-called multifunctional copier, includes a scanner unit 101, an IPU (Image Processing Unit)-A unit 102, an image memory unit 103, a controller unit 104, a printer unit 105, an IPU-B unit 106, a storage unit 107, an IPU-C unit 108, a DSP (Digital Signal Processor) unit 109, a network interface (I/F) circuit 111, a recording medium 112, a medium I/F circuit 1113, and an operations display unit 114.

The scanner unit 101 reads original material (or simply “original”) such as a document, and outputs image data. The image data read and output by the scanner unit 101 are fed to the IPU-A unit 102.

The IPU-A unit 102 performs predetermined image processing suited for the characteristics of the scanner unit 101 and the original on the image data output by the scanner unit 101.

The memory unit 103, which is a volatile memory that temporarily stores image data, includes, for example, a D-RAM (Dynamic-Random Access Memory). For example, the image data subjected to image processing by the IPU-A unit 102 are input to the image memory unit 103 through the controller unit 104 in order to be stored in the image memory unit 103.

On the other hand, the printer unit 105 visualizes (makes visible) input image data by recording the input image data on predetermined paper. Here, for example, the image data stored in the image memory unit 103 are input to the printer unit 105 through the controller unit 104 and the IPU-B unit 106. The IPU-B unit 106 performs predetermined image processing suited for the characteristics of the printer unit data.

Further, the storage unit 107 includes a nonvolatile storage unit that semipermanently stores data, such as an HDD (Hard Disk Drive). For example, the storage unit 107 semipermanently stores image data temporarily stored in the image memory unit 103, and outputs semipermanently stored image data to the image memory unit 103.

The IPC-C unit 108 performs predetermined image processing on image data stored in the image memory unit 103. The image data subjected to the image processing is re-stored in the image memory unit 103.

The DSP unit 109 performs image processing that can be updated by a program on image data stored in the image memory unit 103. The image data subjected to the image processing is re-stored in the image memory unit 103.

Further, the image forming apparatus 10 is connected to the network 30 through the network I/F circuit 111. Other apparatuses such as the PC 20 are connected to the network 30. Each of the apparatuses has an address on the network 30 (for example, an IP address) preset therein. Each apparatus is identified by this address, and performs communications with the other apparatuses connected to the network 30.

The image forming apparatus 10 has the medium I/F circuit 113 into which the recording medium 112 is insertable, so that, for example, image data can be transferred between the recording medium 112 and the image memory unit 103.

The operations display unit 114 has a TPD (Touch Panel Display) integrating a display unit that displays mode options and setting conditions and a detection unit that detects a pressed position of the display unit. The operations display unit 114 is used to provide the operational settings of the image forming apparatus 10.

Further, the controller unit 104, which is a microcomputer system including a CPU and a memory, controls the entire image forming apparatus 10 by giving instructions to each of the above-described units in accordance with a program.

Next, a description is given in detail of the image forming apparatus 10.

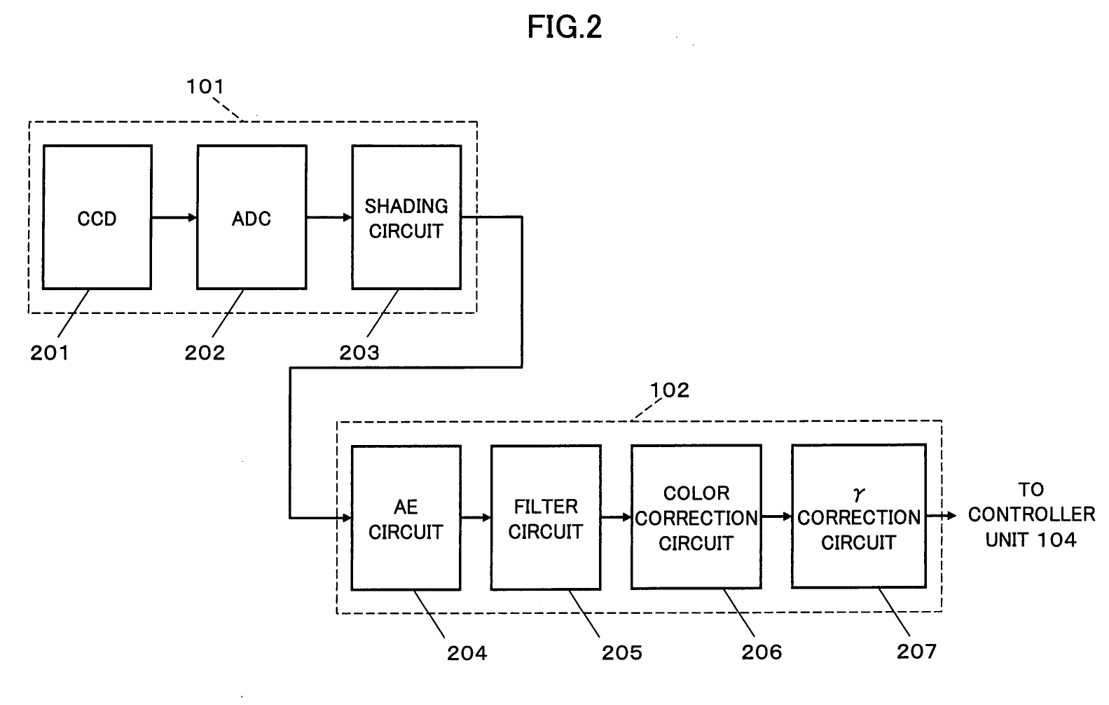

FIG. 2 is a block diagram showing the scanner unit 101 and the IPU-A unit data.

The scanner unit 101 includes a CCD 201, an A/D converter circuit 202, and a shading circuit 203. The CCD 201 performs color separation to separate light from the original into three colors of red (R), green (G), and blue (B), and thereafter performs photoelectric conversion in order to output three analog image signals. The A/D converter circuit 202 converts the image signals output by the CCD 201 into digital signals. The shading circuit 203 corrects variations in the sensitivity of light-receiving elements inside the CCD 201 with respect to the image signals output by the A/D converter circuit 202. The scanner unit 101 performs basic processing for reading an original and outputting it as image data.

The IPU-A unit 102 includes an AE (Automatic Exposure) circuit 204, a filter circuit 205, a color correction circuit 206, and a γ correction circuit 207. The AE circuit 204 detects the background signal level of the original based on input image data, and performs background skipping according to the detected level. The filter circuit 205 smoothes or performs edge enhancement on image data in accordance with an original type specified on the above-described operations display unit 114. The color correction circuit 206 adjusts the color of image data in accordance with the original type in order to convert the color into a unified color independent of original types. The γ correction circuit 207 adjusts the gradation characteristics of image data. The IPU-A unit 102 principally performs image processing according to an original.

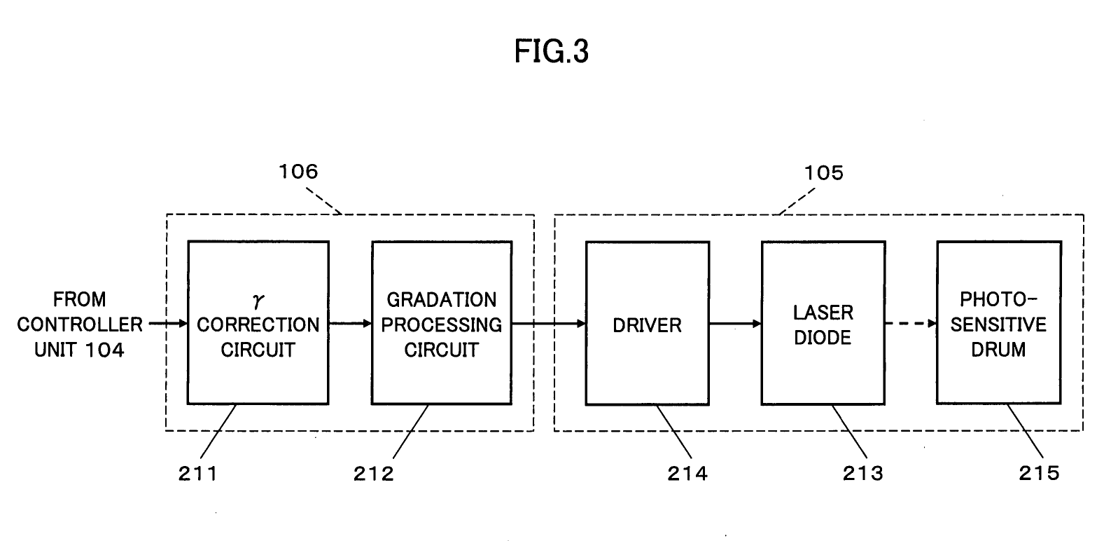

FIG. 3 is a block diagram showing the IPU-B unit 106 and the printer unit 105.

The IPU-B unit 106 includes a γ correction circuit 211 that converts image data in accordance with the gradation characteristics of the printer unit 105, and a gradation processing circuit 212 that realizes pseudo gradation expression in accordance with image data. The IPU-B unit 106 performs correction suited for the characteristics of the printer unit 105.

The printer unit 105 includes a photosensitive drum 215, an LD (Laser Diode) circuit 213 that emits laser light onto the photosensitive drum 215 in accordance with a driving signal, and a driver circuit 214 that converts image data into the driving signal. The printer unit 105 performs basic processing for making the image data visible.

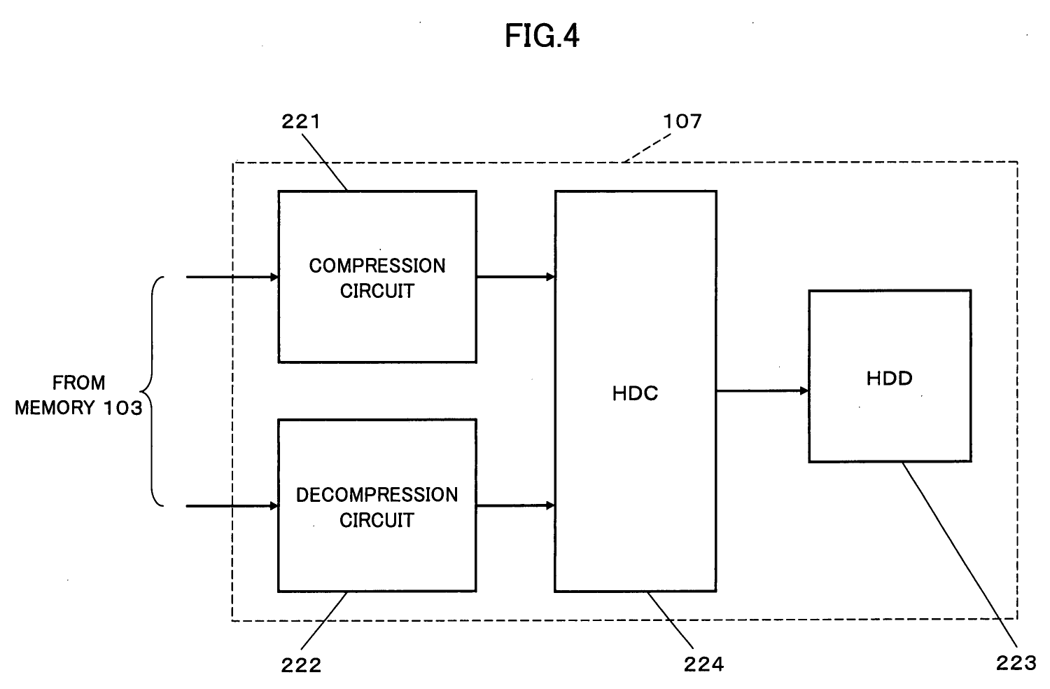

FIG. 4 is a block diagram showing the storage unit 107.

The storage unit 107 includes a compression circuit 211, a decompression circuit 222, an HDD (Hard Disk Drive) 223, and an HDC (Hard Disk Controller) 224. The compression circuit 221 performs compression according to JPEG or JPEG 2000 on input image data. The decompression circuit 222 decompresses compressed image data. The HDC 224 controls writing of the image data compressed by the compression circuit 221 into the HDD 223 and reading of the compressed image data from the HDD 223.

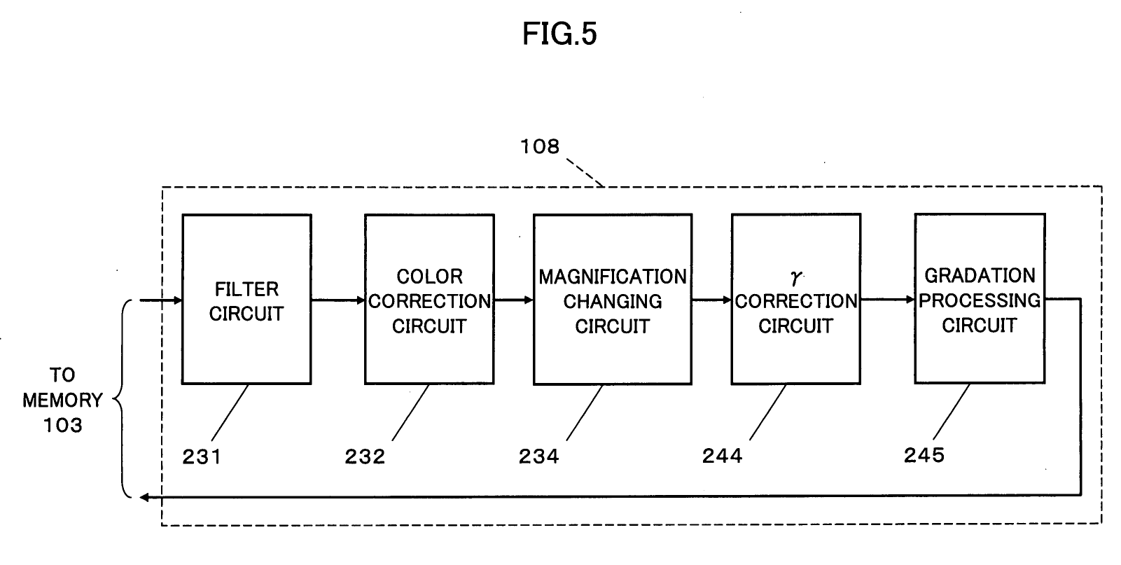

FIG. 5 is a block diagram showing the IPU-C unit 108.

The IPU-C unit 108 includes a filter circuit 231 and a color correction circuit 232. The filter circuit 231 smoothes or performs edge enhancement on image data according to preference. The color correction circuit 232 converts a color image into a black-and-white (B & W) image according to preference, or performs color correction on image data in accordance with an output destination, that is, in accordance with whether the destination of the image data is the printer unit 105 or the PC 20.

The IPU-C unit 108 further includes a magnification changing circuit 234, a γ correction circuit 244, and a gradation processing circuit 245. The magnification changing circuit 234 enlarges or reduces (or changes the resolution of) image data in accordance with the specifications of an output image, such as magnification in the case where the destination is the printer unit 105 and resolution in the case where the destination is the PC 20. The γ correction circuit 244 and the gradation processing circuit 245 are properly used when the destination is the PC 20, etc., that is, when, unlike the printer unit 105, the destination does not have a γ correction circuit or a gradation processing circuit to itself.

Next, a description is given of a data storage structure of the HDD 223 according to this embodiment.

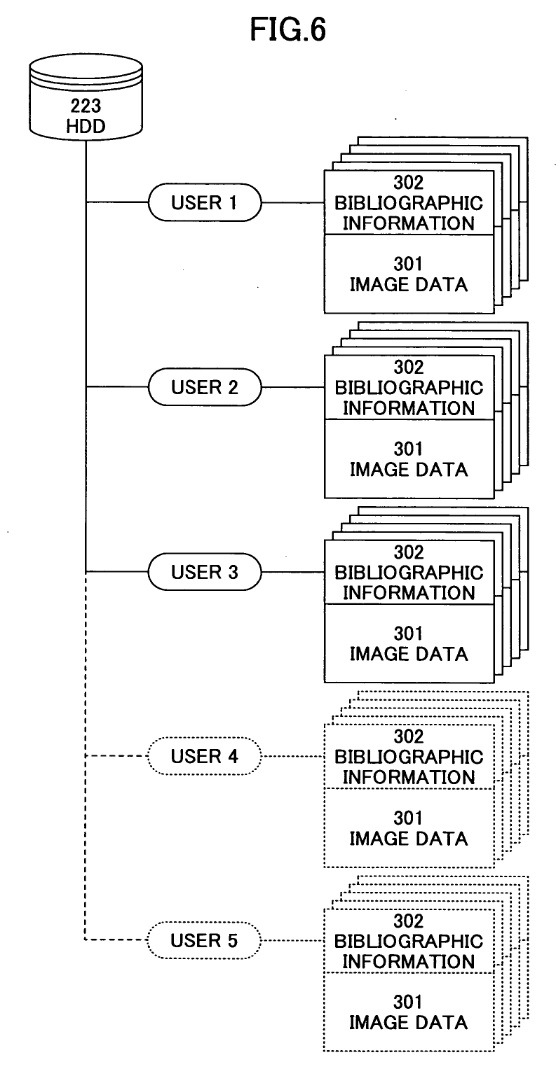

FIG. 6 is a diagram showing a data configuration of the HDD 223.

As described above, compressed image data are written into and stored in the HDD 223. Each image data item 301 has a bibliographic information item 302 showing its attributes added thereto. Hereinafter, the bibliographic information items 302 may be collectively referred to as “bibliographic information 302.”

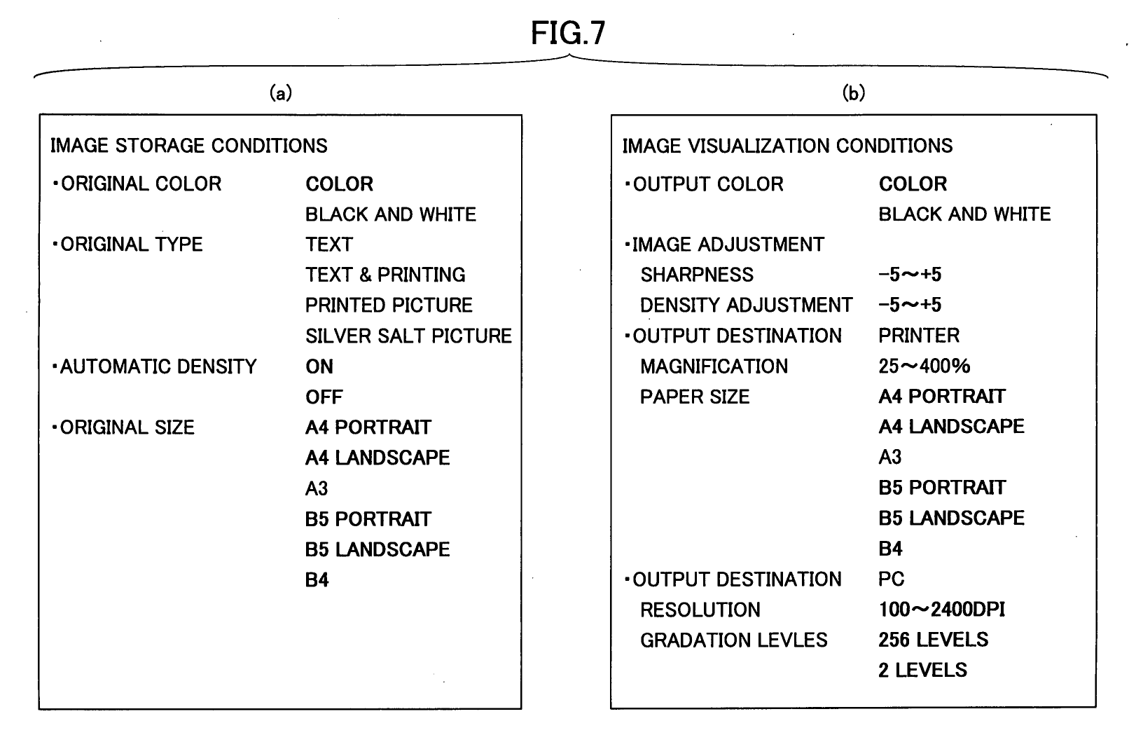

FIG. 7 is a diagram for illustrating the bibliographic information 302. In FIG. 7, (a) indicates bibliographic information at the time of having stored an image, and (b) indicates bibliographic information at the time of having visualized an image.

Thus, the bibliographic information 302 includes information showing conditions at the time of having stored image data as shown in (a) of FIG. 7 and information showing conditions at the time of having visualized image data as shown in (b) of FIG. 7.

As shown in (a) of FIG. 7, the information showing conditions at the time of having stored image data includes an original color (for example, color or black and white), an original type (for example, text, a mixture of text and pictures, a printed picture, or a photographic paper picture), the presence (ON) or absence (OFF) of automatic density correction, and the original size specified at the time of having read an original. These conditions cannot be changed after storage of the image data.

Image processing corresponding to these conditions is performed in the IPU-A unit 102, etc., during a period from reading an original to storage of the original as image data. Therefore, it is difficult to return the conditions to the previous state after storage of the image data.

On the other hand, as shown in (b) of FIG. 7, the information showing conditions at the time of having visualized image data includes the output destination of the image data (for example, the printer unit 105, the PC 20, etc.), the output color of the image data (color or black and white), smoothing or edge enhancement level adjustment information (sharpness) and image density level adjustment information (density adjustment) according to preference, magnification and output paper size information in the case where the destination is the printer unit 105, and resolution information and the number of gradation levels (bi-level or multi-level) in the case where the destination is the PC 20. These conditions can be changed after storage of the image data. Image processing corresponding to these conditions is performed on image data in the IPU-B unit 106 or the IPU-C unit 108 after storage of the image data. Accordingly, the visualization image processing does not affect the stored image data.

In the data configuration shown in FIG. 6, the data are managed user by user in order to maintain and manage security. A user is prevented from accessing the data of another user.

Each user has a recording medium for authentication, which may be the recording medium 112, distributed thereto. Each user uses the recording medium 112 by attaching it to the above-described medium I/F circuit 113. As a result, the user is authenticated and allowed to access corresponding image data.

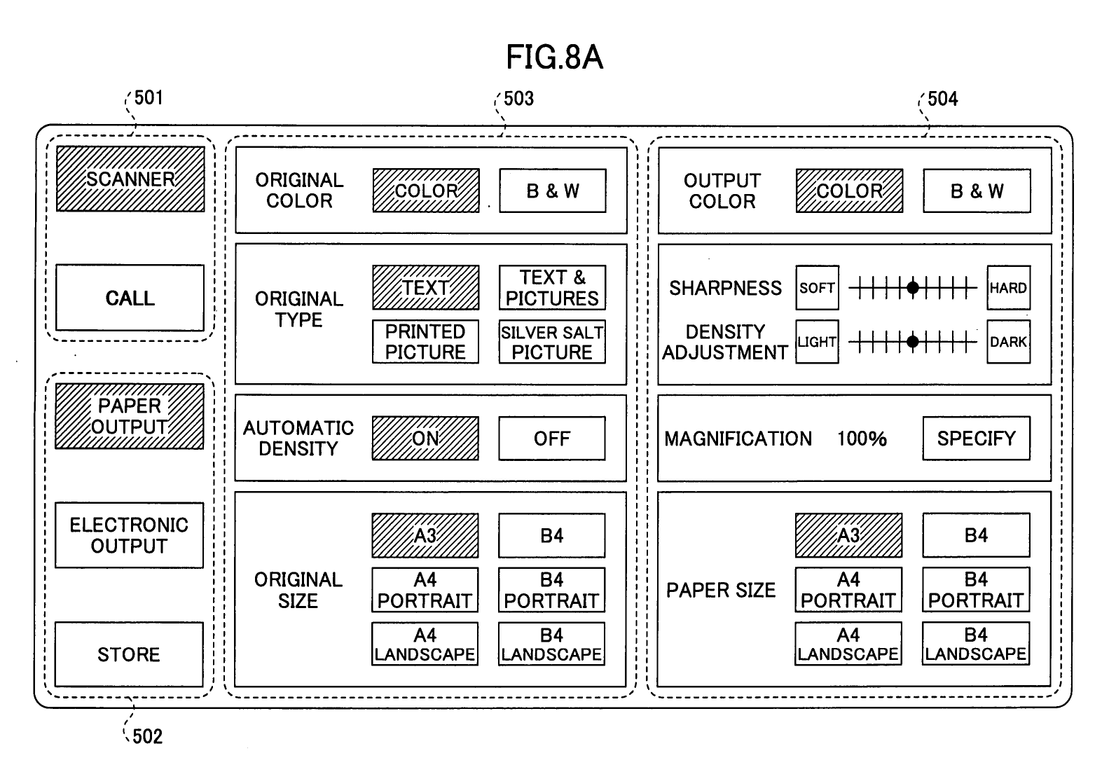

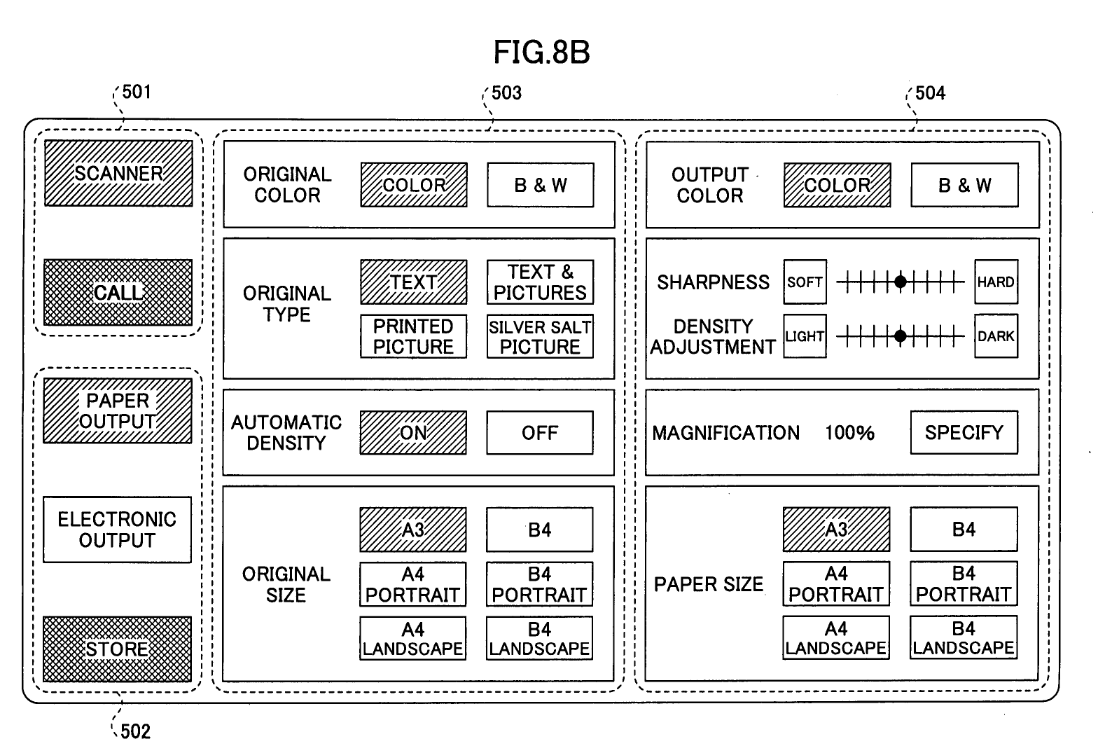

Next, a description is given, with reference to FIGS. 8A through 12, of TPD screens of the operations display unit 114 according to this embodiment. In FIGS. 8A through 12, a part hatched with oblique parallel lines indicates a selected or set function.

FIG. 8A is a standard TPD screen after turning on the image forming apparatus 10.

Referring to FIG. 8A, the screen includes an image input source selection area 501, in which SCANNER is selected in the case of reading an original with the scanner unit 101, and CALL is selected in the case of calling image data stored in the storage unit 107.

In an image output destination selection area 502, PAPER OUTPUT is selected in the case of recording image data on paper with the printer unit 105, ELECTRONIC OUTPUT is selected in the case of transmitting image data to, for example, the PC 20, and STORE is selected in the case of storing image data in the storage unit 107.

In FIG. 8A, a so-called copy mode, in which an original is read with the scanner unit 101 and recording is performed on paper with the printer unit 105, is selected.

A user is not authorized to access the storage unit 107 unless the user is authenticated. FIG. 8A shows the case where a user is authenticated. If a user is not authenticated, CALL and STORE indicated by crosshatching in FIG. 8B are displayed differently from the case where CALL and STORE are selectable, for example, dimmed, and are not selectable.

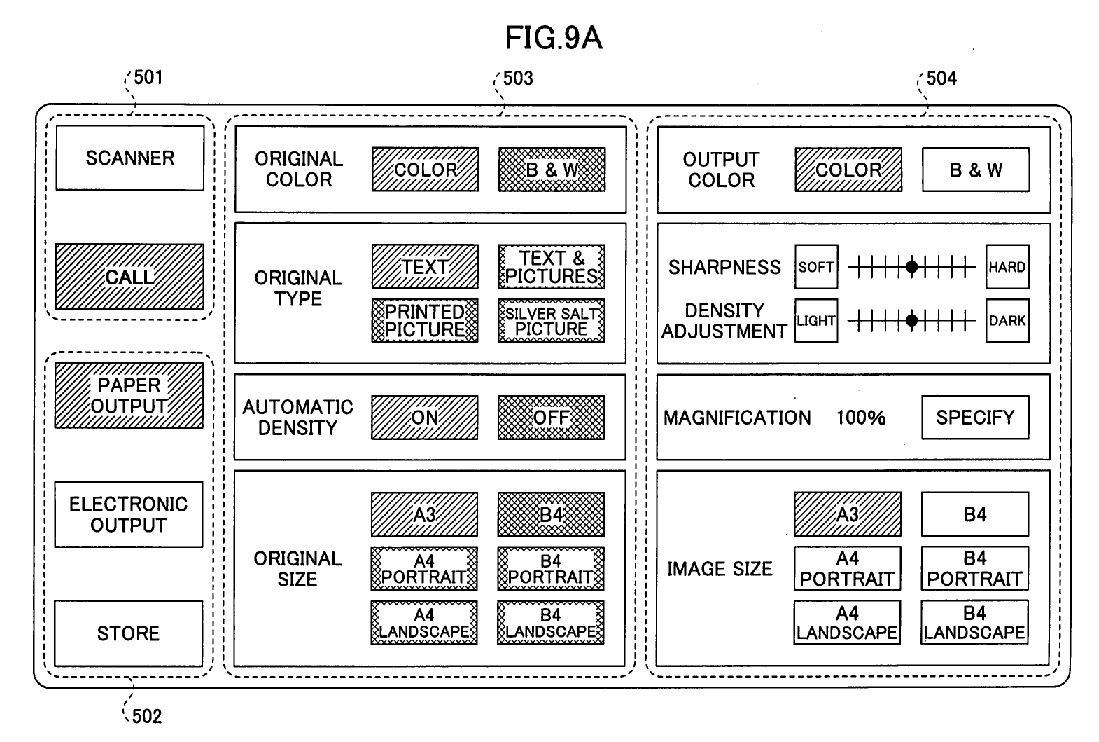

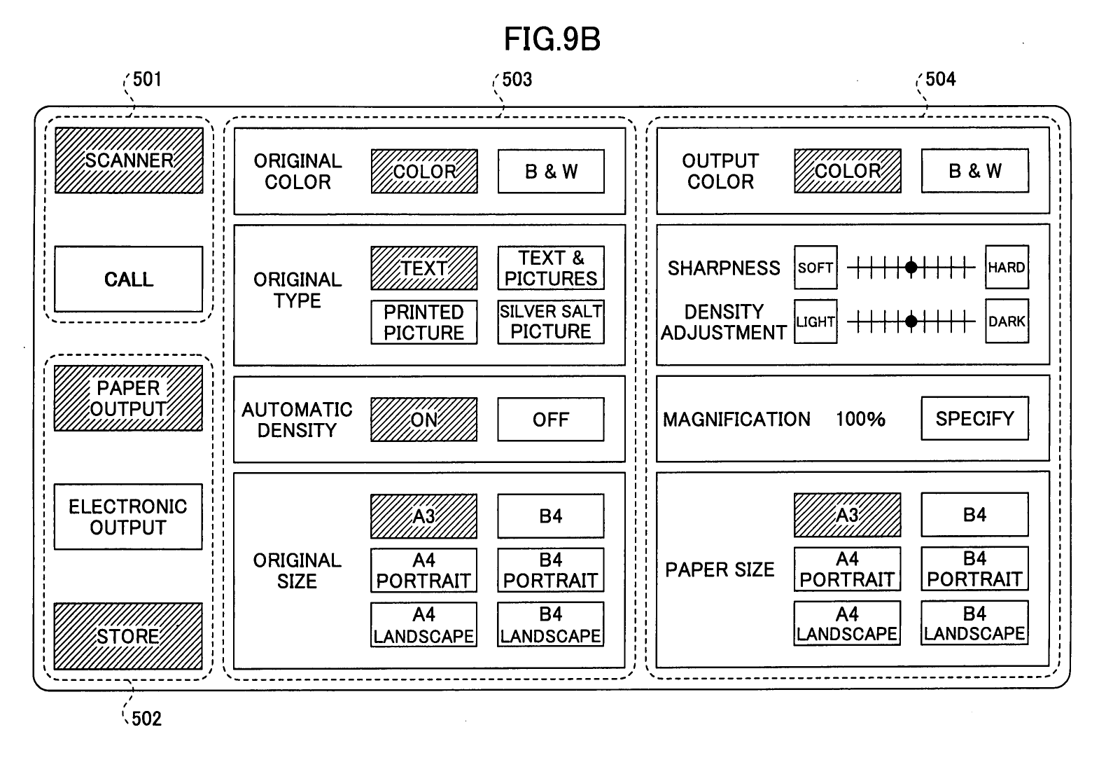

The screen of FIG. 8A further includes an original reading conditions setting area 503, in which the color of an original to be read, for example, color or black and white, the type of the original, that is, text, a mixture of text and pictures, a printed picture, or a photographic paper picture, ON/OFF of automatic density correction, and the size of the original are set. These selections can be made when SCANNER is selected in the image input source selection area 501. If CALL is further selected, the selected original reading conditions of image data indicated by hatching with oblique parallel lines in FIG. 9A are highlighted, and the other original reading conditions of the image data indicated by crosshatching in FIG. 9A are displayed differently from the selected original reading conditions of the image data, for example, dimmed. The dimmed conditions cannot be selected.

The screen of FIG. 8A further includes an image visualization conditions setting area 504, whose display contents differ depending on the status of the image output destination selection area 502. For example, since PAPER OUTPUT is selected in FIG. 8A, it is possible to determine a color mode at the time of outputting paper, that is, color or black and white; the adjustment levels of sharpness and density adjustment; magnification; and paper size.

Further, with the status shown in FIG. 8A, it is also possible to select STORE as an image output destination at the same time. That is, it is possible to store image data while making copies. FIG. 9B shows a TPD status at this point.

At the time of STORE, since no visualization is performed, it is not necessary to set image visualization conditions. Accordingly, the conditions of PAPER OUTPUT, for example, information such as output color, sharpness, density adjustment, magnification, and paper size is displayed in the image visualization conditions setting area 504.

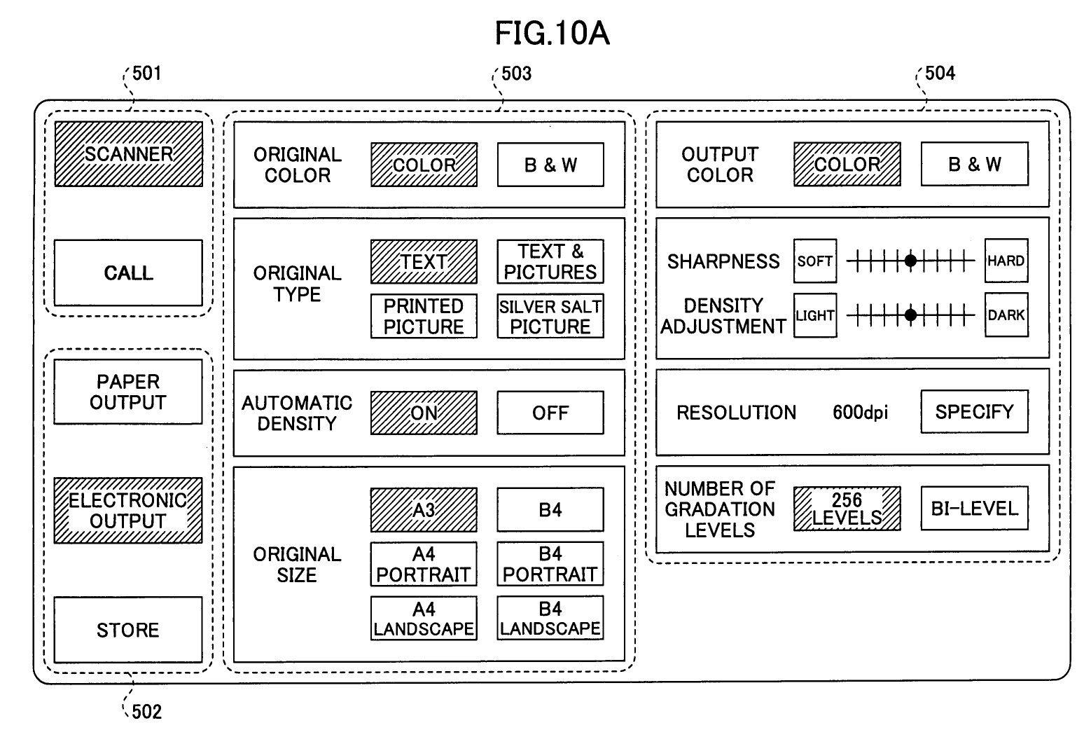

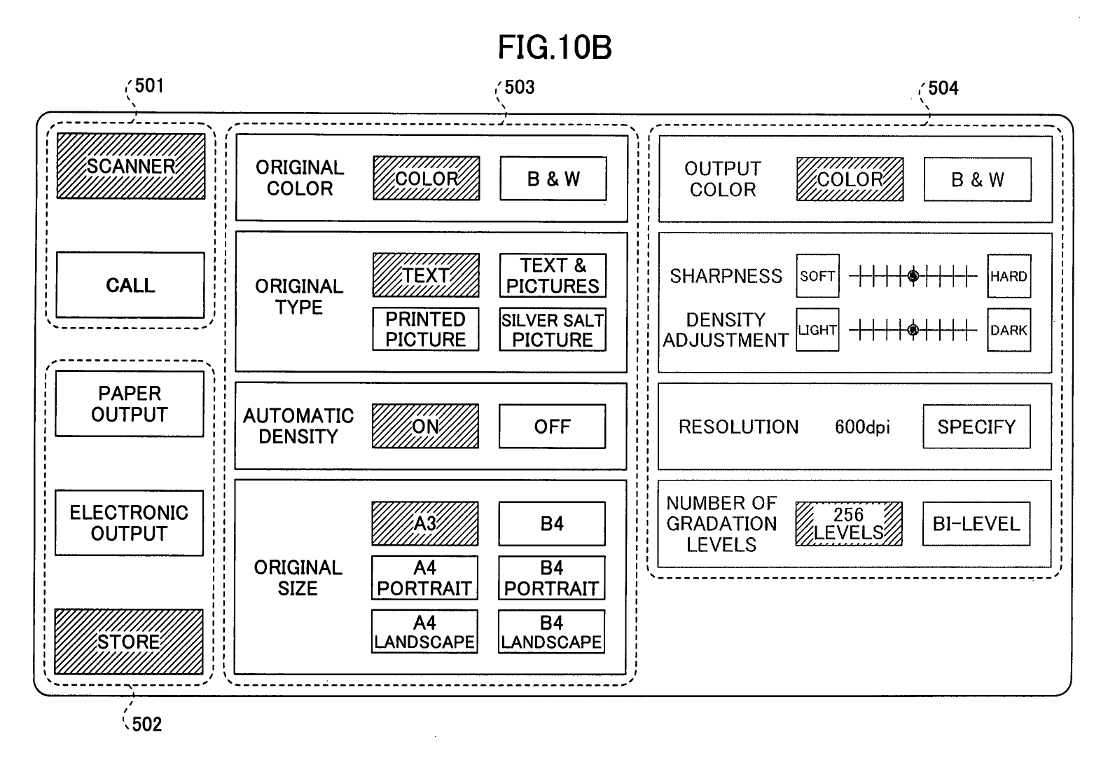

FIG. 10A shows a display in the case where ELECTRONIC OUTPUT is selected in the image output destination selection area 502. In this case, information for setting a color mode at the time of electronic outputting (color or black and white), the adjustment levels of sharpness and density adjustment, resolution, and the number of gradation levels of image data, that is, 256 gradation levels or bi-level, is displayed in the image visualization conditions setting area 504.

Although not described in detail herein, it is necessary to specify an output destination on the network 30 if a user selects ELECTRONIC OUTPUT. Therefore, a list of apparatuses connected to the network 30 can be displayed on the operations display unit 114, and the user performs operations such as selecting an output destination on the network 30 from the apparatus list.

FIG. 10B shows a display in the case where STORE is selected alone in the image output destination selection area 502.

In this case, the image visualization conditions setting area 504 has no meaning. Accordingly, all the options in the image visualization conditions setting area 504 surrounded by the broken line in FIG. 10B are dimmed and cannot be selected.

Next, a description is given of the case where CALL is selected in the image input source selection area 501.

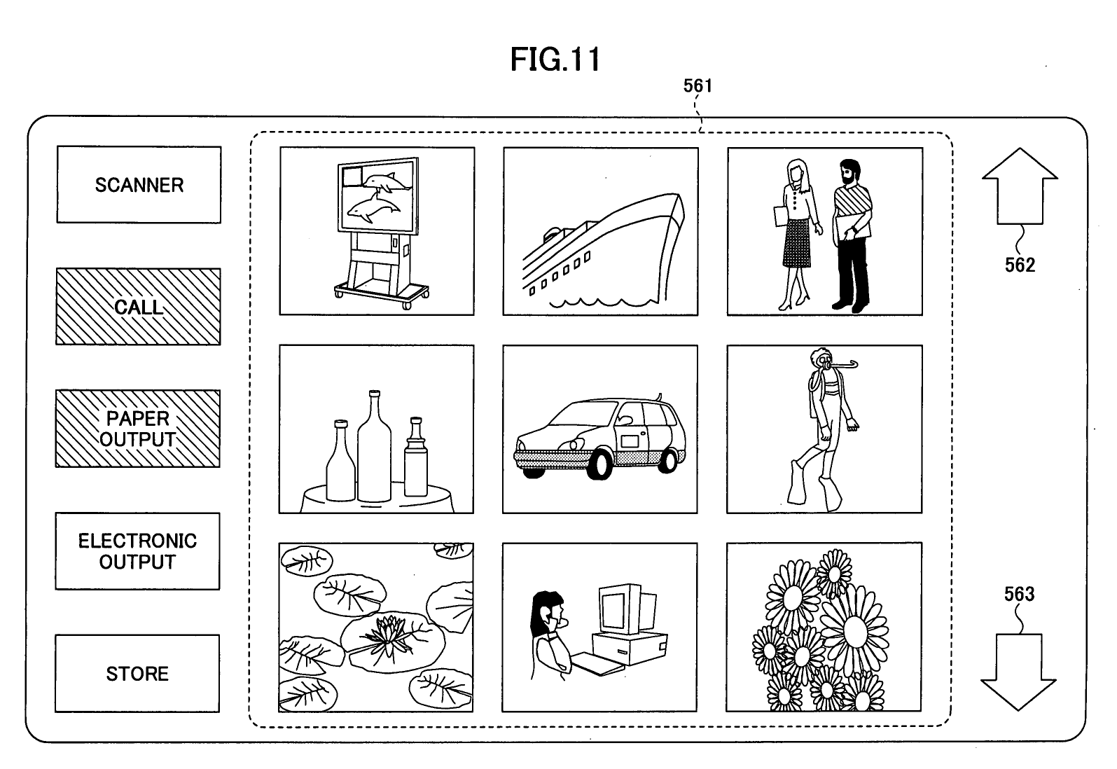

When a user selects CALL, first, a list of image data stored in the storage unit 107 is displayed, for example, as shown in FIG. 11, so that a desired image can be selected.

The screen of FIG. 11 includes a stored image selection area 561, in which the thumbnail images of image data stored in the storage unit 107 are displayed in a list. If there are more thumbnail images than can be displayed at a time in the stored image selection area 561, those that are not displayed are successively displayed by operating a scroll key display unit 562 or 563. Only images accessible by the user are displayed in a list. The user can select image data by touching a corresponding thumbnail image.

Next, when the user selects a desired image, a screen as shown in FIG. 9A is displayed. The conditions at the time of having stored the image are extracted from the bibliographic information corresponding to the image data, and are displayed in the original reading conditions setting area 503. Further, the image visualization conditions of the image extracted from the bibliographic information are displayed in the image visualization conditions setting area 504, and the output destination extracted from the bibliographic information is displayed in the image output destination selection area 502.

With respect to image data for which STORE is selected alone in the image output destination selection area 502, there is no need to set image visualization conditions. According to this embodiment, however, standard visualization conditions as shown in FIG. 9A, for example, are automatically selected and displayed in consideration of later use.

The image visualization conditions selected and set when CALL is selected in the image input source selection area 501 overwrite the bibliographic information of the image data when the conditions are determined or fixed, that is, when PAPER OUTPUT or ELECTRONIC OUTPUT is selected in the image output destination selection area 502.

As a result, when the image data are used next time, their previously selected image visualization conditions are read out with the selection of the image data. This saves readjustment of sharpness and density, thus making it possible to improve usability in the case of reusing image data.

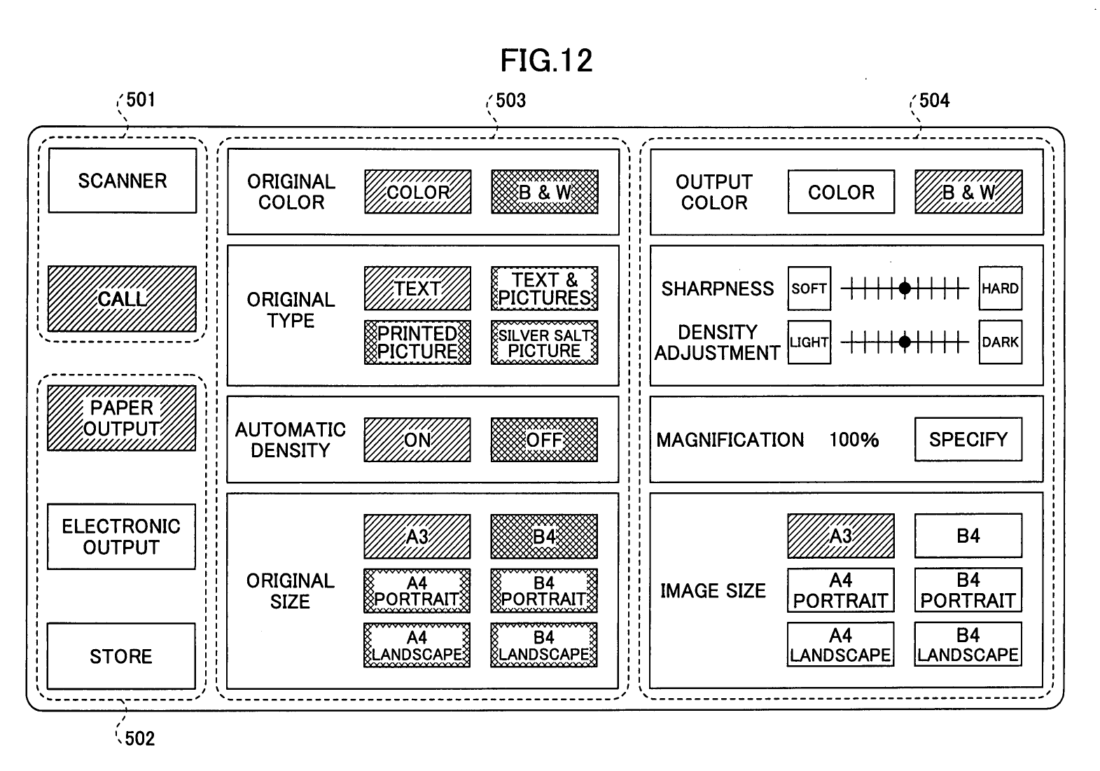

For example, it is assumed that the output color is changed to black and white from the state shown in FIG. 9A. In this case, a screen as shown in FIG. 12 is displayed.

Then, if PAPER OUTPUT is selected in the image output destination selection area 502, an operation corresponding to the set conditions is performed, and the bibliographic information of the image visualization conditions stored in the storage unit 107 is updated by the conditions at this time.

Therefore, when the image is selected from a thumbnail image list next time, the latest screen as shown in FIG. 12 is displayed, so that there is no need to perform another operation to change the output color to black and white.

Processing

Next, a description is given of processing of the controller unit 104 at the time of storing an image and outputting a stored image.

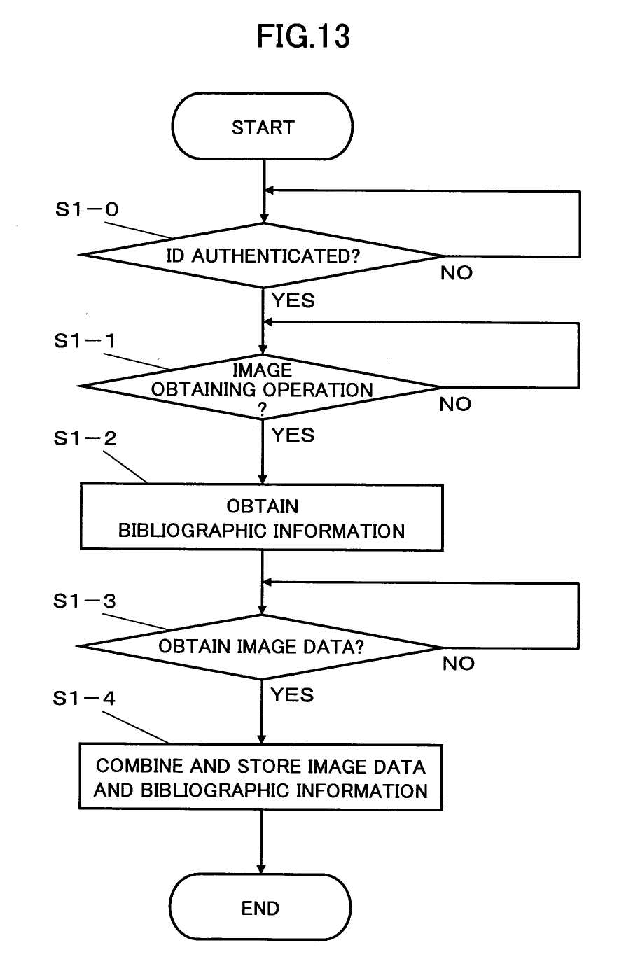

FIG. 13 is a flowchart of processing of the controller unit 104 at the time of storing an image.

If the ID of a user is authenticated in step S1-0 and the user performs an operation to obtain an image in step S1-1, in step S1-2, the controller unit 104 obtains bibliographic information that is set at the time of obtaining the image. If the data on the image is obtained in step S1-3, in step S1-4, the controller unit 104 combines and stores the obtained image data and the bibliographic information set at the time of obtaining the image data.

Since this bibliographic information is the conditions at the time of obtaining the image, that is, at the time of storing the image, it is not authorized to change the bibliographic information later.

Thereby, image data and their bibliographic information are stored, with the data configuration shown in FIG. 6, in the HDD 223 forming the storage unit 107.

Next, a description is given of processing at the time of outputting a stored image.

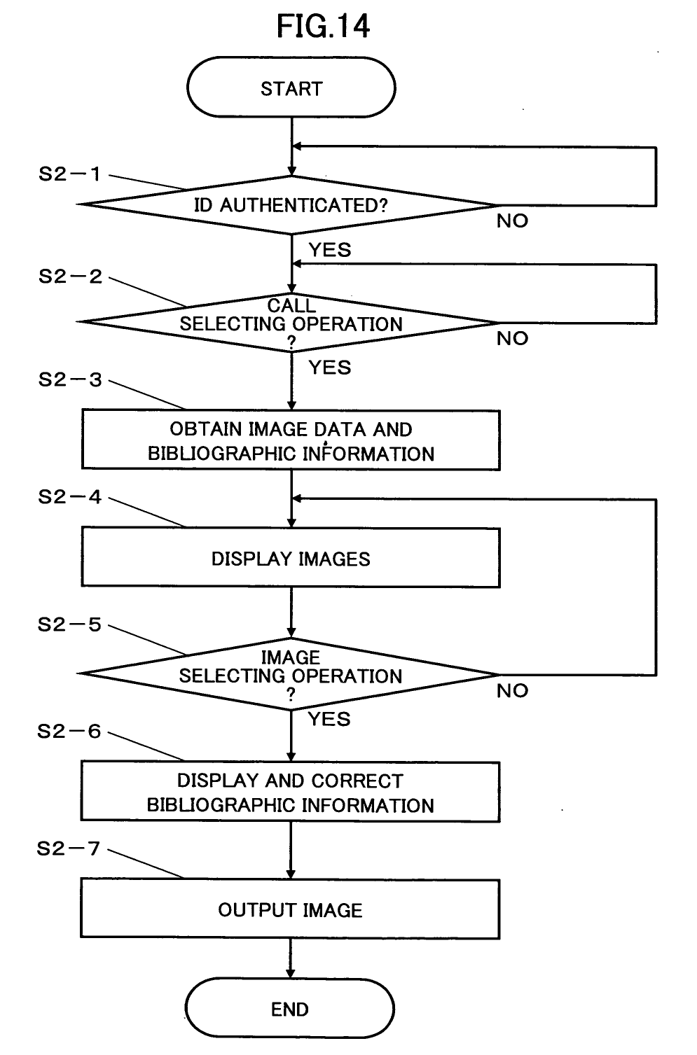

FIG. 14 is a flowchart of processing of the controller unit 104 at the time of outputting a stored image.

If the ID of a user is authenticated in step S2-1 and the user performs an operation to select CALL in step S2-2, in step S2-3, the controller unit 104 obtains image data and their bibliographic information corresponding to the user from the storage unit 107, and in step S2-4, displays corresponding images in a list as shown in FIG. 11.

If a desired image is selected from the displayed images in step S2-5, in step S2-6, the controller unit 104 displays the bibliographic information set for the selected image as shown in FIG. 9A, and receives a correction input if necessary. Thereafter, in step S2-7, the controller unit 104 causes, for example, the IPU-B unit 106 to perform an operation to read the image, and outputs the image to the printer unit 105. If the bibliographic information is corrected in step S2-6, the corrected bibliographic information overwrites the bibliographic information stored in the storage unit 107, and is stored therein.

The bibliographic information updated by this overwriting includes conditions that can be changed after storage, that is, the conditions at the time of outputting or visualizing the image. On the other hand, the conditions at the time of having obtained or stored the image are maintained as they are.

Effects

According to an image processing method that stores image data in a storage unit according to one embodiment of the present invention, the image data and data related to processing performed on the image data are stored in correlation with each other in the storage unit, so that in the case of reusing the image data, it is possible to easily refer to the corresponding processing-related data. Therefore, it is possible to improve usability by setting processing referring to the corresponding processing-related data.

Further, according to an image forming apparatus that stores and manages image data in a storage unit according to one embodiment of the present invention, the image forming apparatus includes a control unit configured to store the image data and data related to processing performed on the image data in correlation with each other in the storage unit, so that in the case of reusing the image data, it is possible to easily refer to the corresponding processing-related data. Therefore, it is possible to improve usability by setting processing referring to the corresponding processing-related data.

Further, according to an image processor according to one embodiment of the present invention, the image processor includes a selection unit configured to select desired image data from image data stored in a storage unit; and a setting changing unit configured to display data related to processing, the data being stored in correlation with the selected image data in the storage unit, and to change an output setting based on the displayed processing-related data, so that in the case of reusing the image data, it is possible to easily change the setting of processing based on the corresponding processing-related data. Therefore, it is possible to improve usability.

Further, conditions that can be changed after storage of image data, that is, the conditions at the time of having output or visualized an image, may be updated whenever necessary so that previously selected conditions are stored. Thereby, it is possible to further improve usability.

Thus, according to one embodiment of the present invention, image data and data related to processing performed on the image data are stored in correlation with each other in a storage unit, and necessary bibliographic information is obtained referring to the image data stored in the storage unit at the time of image reading. Thereby, it is possible to utilize initial values, so that it is possible to omit unnecessary setting operations. As a result, it is possible to improve usability.

The present invention is not limited to the specifically disclosed embodiment, and variations and modifications may be made without departing from the scope of the present invention.

For instance, in the description of this embodiment, a multifunctional copier is taken as an example. However, the fields of application of the present invention are not limited to the multifunctional copier. The present invention is also applicable to, for example, a personal computer system to which a scanner and a printer are connected.

What is claimed is:

1. An image processing method that stores image data in a storage unit, wherein:
the image data and data related to processing performed on the image data are stored in correlation with each other in the storage unit.

2. The image processing method as claimed in claim 1, wherein the data related to the processing performed on the image data include processing-related data prevented from being changed after storage thereof.

3. The image processing method as claimed in claim 2, wherein the processing-related data prevented from being changed after the storage thereof comprise processing executed on image data read at a time of reading an image.

4. The image processing method as claimed in claim 2, wherein the processing-related data prevented from being changed after the storage thereof include at least one of a color of an original material, a type of the original material, presence or absence of automatic density correction, and a size of the original material.

5. The image processing method as claimed in claim 1, wherein the data related to the processing performed on the image data include processing-related data changeable after storage thereof.

6. The image processing method as claimed in claim 5, wherein the processing-related data changeable after the storage thereof comprise processing executed on read image data.

7. The image processing method as claimed in claim 5, wherein the processing-related data changeable after the storage thereof includes at least one of a color mode, an adjustment level of sharpness, an adjustment level of density, resolution, and a number of gradation levels of the image data.

8. The image processing method as claimed in claim 1, wherein desired image data are selected from the image data stored in the storage unit, and image processing is performed based on bibliographic information of the selected image data.

9. An image forming apparatus that stores and manages image data in a storage unit, the image forming apparatus comprising:
a control unit to store the image data and data related to processing performed on the image data in correlation with each other in the storage unit.

10. The image forming apparatus as claimed in claim 9, wherein the control unit selects desired image data from the image data stored in the storage unit, and performs image processing based on bibliographic information of the selected image data.

11. An image processor, comprising:
a selection unit to select desired image data from image data stored in a storage unit; and
a setting changing unit to display data related to processing, the data being stored in correlation with the selected image data in the storage unit, and to change an output setting based on the displayed processing-related data.
